(19) United States
(12) Patent Application Publication
(10) Pub. No.: US 2003/0070544 A1
(43) Pub. Date: Apr. 17, 2003

(54) System and method for determining filter condition

(75) Inventors: Patrick T. Mulvaney, Glen Allen, VA (US); Marron Hak, Richmond, VA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Hamilton Beach/Proctor-Silex, Inc.

(21) Appl. No.: 10/271,481

(22) Filed: Oct. 15, 2002

Related U.S. Application Data
(60) Provisional application No. 60/329,481, filed on Oct. 15, 2001.

(51) Int. Cl. B01D 46/46

(52) U.S. Cl. 95/25; 95/1; 96/417

(57) ABSTRACT

A system and method for determining the condition of a filter in a forced air filtration system includes a blower motor and a fan mounted for rotation with an output shaft of the blower motor. A load sensor is operably connected to the blower motor for monitoring an electric load of the motor. As the filter becomes increasingly laden with airborne particles, the electric load changes. The load sensor generates a load value dependent on the electric load of the motor which is compared to a predetermined value. When the load value reaches the predetermined value, a signal is generated indicative of a filter change condition.

### CROSS-REFERENCE TO RELATED APPLICATIONS

This application claims the benefit of U.S. Provisional Patent Application No. 60/329,481 filed on Oct. 15, 2001, the disclosure of which is hereby incorporated by reference in its entirety.

### BACKGROUND OF THE INVENTION

The present invention relates to forced air systems, and more particularly to a system and method for determining the life of an air filter in forced air systems, such as HVAC systems, air purifiers, vacuum cleaners, humidifiers with prefilters, and so on.

Forced air systems are often employed to accomplish a particular task, such as heating, cooling and/or purifying the air in an enclosed structure, cleaning carpets and other surfaces, providing air pressure to air-powered tools, and so on. Airborne particles often travel through such systems and, unless removed, can affect various components of the system, leading to decreased operational efficiency, increased operating costs, and/or premature failure of system components.

In addition, personal contact with contaminants such as pollen, mold, smoke, dust, pet dander, micro-organisms, or any other of a number of known irritants makes breathing uncomfortable for some individuals. Such contaminants may present long-term health risks, particularly for those individuals suffering from allergies, asthma, emphysema, and other respiratory-related illnesses.

In order to overcome these problems, forced air systems typically employ one or more air filters for removing airborne contaminants. Such filters range in quality from simple low-cost filters for entrapping only larger airborne particles to high quality electrostatic filters that attract and entrap relatively small airborne particles. One type of air filter which has gained wide spread acceptance within the industry is a high efficiency particulate air (HEPA) filter which typically entraps particles of 0.3 microns or larger in size.

No matter what type of filter is used, the filter can become blocked with contaminants over time, resulting in an increase in the pressure drop across the filter, which in turn causes the blower motor to pull or push less air through the filter. As less air is forced through the filter, the effectiveness of the forced air system decreases. At some point, the filter becomes too laden with particulate material to allow for efficient air filtration, and thus the efficient movement of air through the forced air system. Accordingly, the air filter must be removed and either cleaned or replaced with a new air filter. If the filter is replaced before this point, some of the useful life of the air filter is wasted. Conversely, if the filter is replaced after this point, energy is wasted on the inefficient running of the forced air system. Depending on the type and size of the forced air system and the air filter(s) used in the system, the particular point at which the air filter should be changed can greatly vary.

Previous methods of determining the change point of a used filter have included various timers that are based on predetermined usage patterns or motor run time. These methods, however, do not take into account the environment in which the forced air system is used. An environment with a high amount of airborne contaminants necessitates more frequent filter replacement than an environment with relatively little airborne contaminants. Other methods for determining the change point of a used filter include measuring a pressure drop across the filter, optical measurement of the filter material, as well as visual inspection of the filter itself.

### BRIEF SUMMARY OF THE INVENTION

The present invention comprises a system and method for determining the condition of an air filter in a forced air system. A forced air filtration system in accordance with one aspect of the present invention comprises a housing having an air inlet and an air outlet. The housing can be in the form of an air cleaner housing, a vacuum cleaner housing, ductwork in an HVAC system, and so on. An air filter is positioned in an airflow pathway between the air inlet and the air outlet. A blower assembly has an electric motor with an output shaft and a fan that is mounted for rotation with the output shaft. The blower assembly is positioned for directing air flow from the air inlet, through the air filter and out of the air outlet. Circuitry is operably connected to the electric motor and includes a load sensor for monitoring an electric load of the motor. The load sensor generates a load value dependent on the electric load of the motor. An indicator is provided for indicating a condition of the air filter based on the load value.

In accordance with a further aspect of the invention, a forced air filtration system comprises a housing and an air filter positioned in an airflow pathway between an air inlet and air outlet of the housing. A blower assembly has an electric motor with an output shaft and a fan that is mounted for rotation with the output shaft. The blower assembly is positioned for directing air flow through the air filter and out of the air outlet. Circuitry is operably connected to the electric motor. The circuitry comprises a current sensor for measuring a current draw of the electric motor and generating a load value dependent on the electric load of the motor, and a comparator that is electrically connected to the current sensor for comparing the load value to a predetermined value indicative of a filter change point. An indicator is operably associated with the comparator for indicating at least the filter change point.

In accordance with an even further aspect of the invention, a method for sensing a change point of a filter in a forced air filtration system having an electric blower motor and a fan connected to an output shaft of the blower motor for rotation therewith to thereby direct air through the filter is provided. The method comprises monitoring an electric load of the blower motor, generating a load value dependent on the electric load of the motor, and indicating a change point of the air filter based on the load value.

In accordance with yet a further aspect of the invention, a method of determining a filter life of an air filter used in a forced air filtration system to alert a user of a dirty-filter condition is provided. The method comprises actuating a fan motor to force air through the air filter, measuring a current passing through the fan motor, determining a speed of the fan motor from the measured current, comparing the speed of the fan motor to a predetermined value to determine the filter life, and actuating an alert if the speed of the fan motor is greater than the predetermined value.

### BRIEF DESCRIPTION OF THE DRAWINGS

The following detailed description of the preferred embodiment of the present invention will be better understood when read in conjunction with the appended drawings. For the purpose of illustrating the invention, there is shown in the drawings an embodiment which is presently preferred. It is understood however, that the invention is not limited to the precise arrangements and instrumentalities shown. In the drawings:

FIG. 1 is a front perspective view of a forced air system in the form of an air purifier incorporating a device for detecting an air filter change point;

FIG. 2 is a an exploded front perspective view of the air purifier shown in FIG. 1;

FIG. 3 is a front elevational view of the air purifier shown in FIG. 1;

FIG. 4 is an enlarged cross-sectional view of the air purifier taken along line 4-4 of FIG. 3;

FIG. 5 is a performance characteristic curve of a typical air purifier fan motor;

FIG. 6 is a schematic diagram of a first circuit for detecting and indicating the condition of an air filter in accordance with an exemplary embodiment of the invention;

FIG. 7 is a schematic diagram of a second circuit for detecting and indicating the condition of an air filter in accordance with a further embodiment of the invention; and

FIG. 8 is a schematic diagram of a third circuit for detecting and indicating the condition of an air filter in accordance with an even further embodiment of the invention.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inwardly” and “outwardly” refer to directions toward and away from, respectively, the geometric center of the air purifier and designated parts thereof. The terminology includes the words above specifically mentioned, derivatives thereof, and words of similar import.

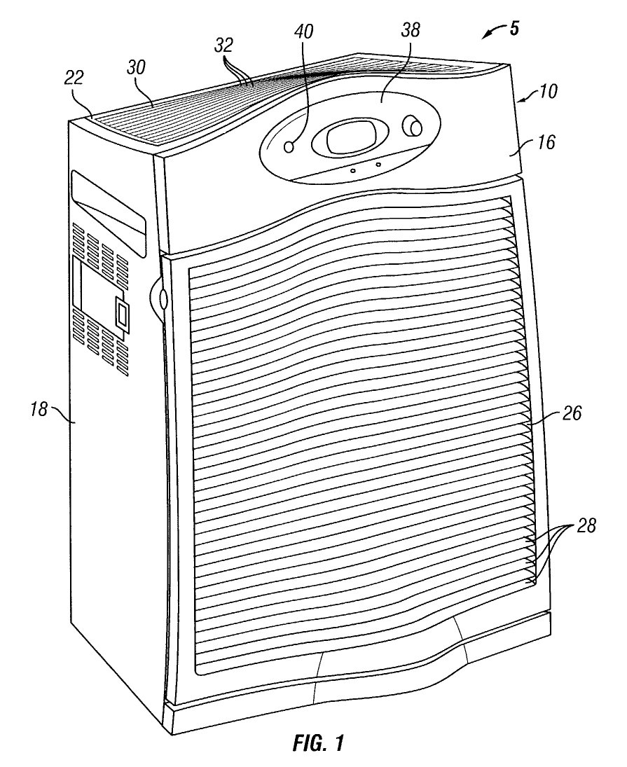

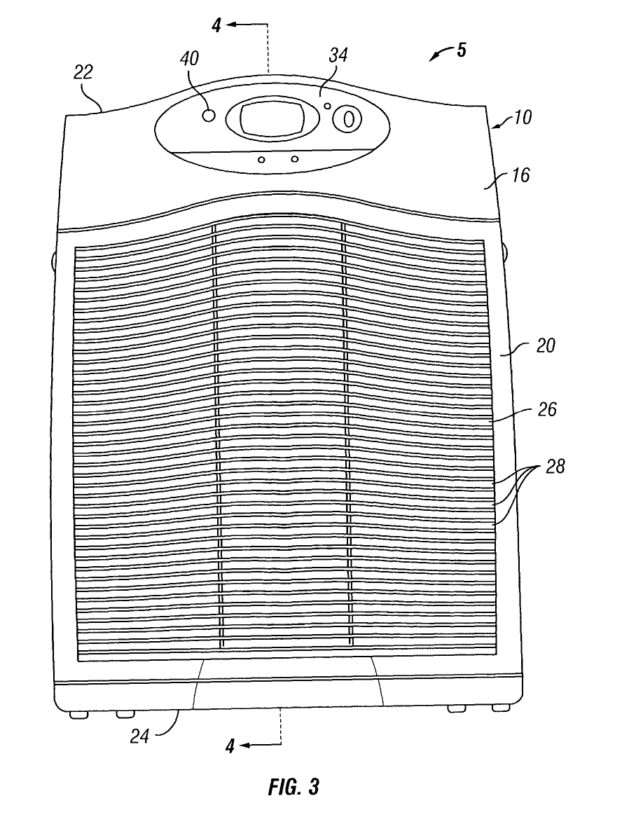

With reference now to the drawings, and to FIGS. 1-3 in particular, a forced air system in the form of an air purifier 5 in accordance with the present invention is illustrated. It will be understood that the air purifier 5 is given by way of example only, and that the forced air system can be any system where air under pressure is forced through an air filter by an electric blower assembly, such as HVAC systems, vacuum cleaners, humidifiers with prefilters, and so on.

The air purifier 5 includes a housing 10 with a hollow interior 12 formed by a rear wall 14, a front wall 16 spaced from the rear wall, side walls 18 and 20 that extend between the front and rear walls, a top wall 22 and a bottom wall 24 connected to upper and lower ends, respectively, of the front, rear and side walls. The front wall 16 includes an air inlet in the form of a removable grill 26 with slots 28 through which air is drawn into the housing 10. The top wall 22 includes an air outlet in the form of a grill 30 with slots 32 through which air is forced out of the housing 10. An air filter assembly 34 and a blower assembly 36 are positioned in the hollow interior 12.

A control/display panel 38 is located on the housing 10 by which air purifier settings can be adjusted and displayed. The control/display panel 38 preferably includes an indicator 40 for alerting a user when the air filter should be replaced. The indicator 40 preferably comprises a light-emitting diode (LED), but may alternatively be in the form of any well-known display.

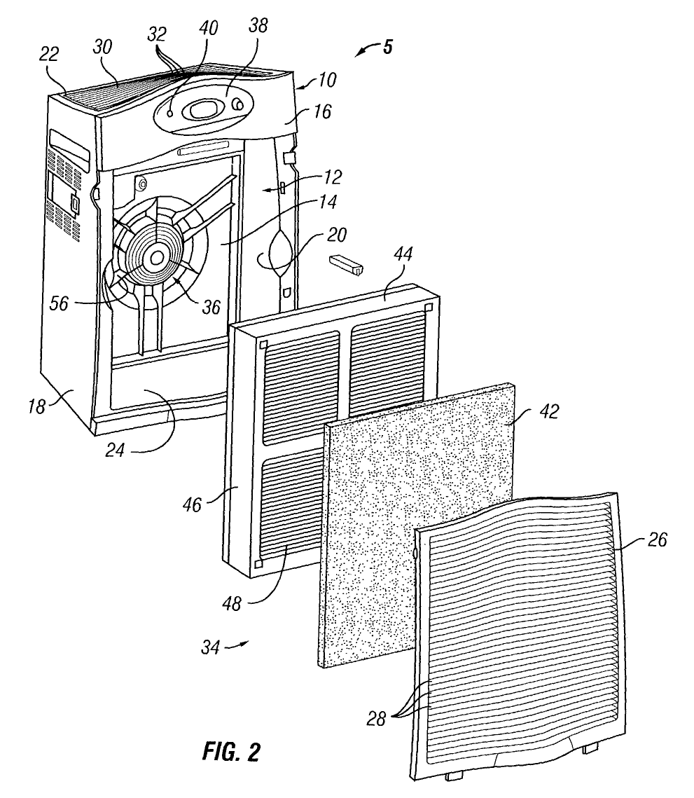

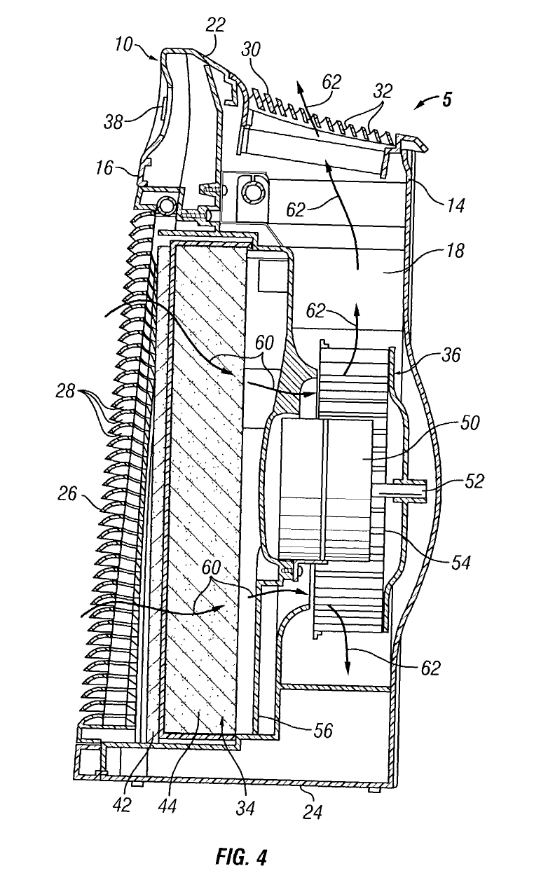

As shown in FIGS. 2 and 4, the air filter assembly 34 has a pre-filter 42 and a high efficiency particulate air (HEPA) filter 44 that are accessible through the removable grill 26. The HEPA filter 44 is used to entrap airborne particulates in the submicron range. The HEPA filter 44 includes a support frame 46 for supporting pleated filtration material 48. The filtration material 48 is preferably of the type that provides a minimum efficiency of 99.97 percent on 0.3 micron size particles, which results in a high degree of filtration in environments where airborne micro-organism concentrations pose a hazard. In addition, the HEPA filter 44 is capable of removing other airborne contaminants such as dust, pollen, mold spores, and the like.

The pre-filter 42 is generally of relatively low efficiency and overlies the HEPA filter 44. Generally, the pre-filter 42 is used for trapping larger airborne particles such as lint, dust, pollen, and the like, before they enter the HEPA filter 44 to extend the HEPA filter life. As such, the pre-filter 42 may be replaced substantially more frequently than the HEPA filter 44. The pre-filter 42 preferably includes carbon for the treatment of odors, fumes, and other noxious vapors which may be present in the incoming air flow. It will be understood that more or less filters may be provided for the forced air system, and that such air filters are not limited to the charcoal or HEPA filter types, but rather may encompass any material that is capable of entrapping airborne particles and, consequently, is subject to particle build-up over time.

The blower assembly 36 includes an electric motor 50 with a shaft 52 and a cage-type fan 54 that is connected to the shaft for rotation therewith. The electric motor 50 is mounted to the rear wall 14 through a bracket assembly 56. It will be understood that the blower assembly 36 is not limited to the particular arrangement as shown and described, but can comprise any electric motor with any fan that is associated with a forced air filtration system that is capable moving air from one location to another. It will be further understood that the blower assembly 36 can be located at other positions either inside or outside of the housing 10.

As shown in FIG. 4, operation of the blower assembly causes air to be drawn into the air inlet, in this instance through the slots 28 of the removable grill 26, through the filter assembly 34, including the pre-filter 42 and HEPA filter 44, and into the fan 54 of the blower assembly 36, as represented by arrows 60. From there, the filtered air is forced under pressure through the air outlet, in this instance through the slots 32 of the grill 30, and into the room in which the air purifier 5 is located, as represented by arrows 62.

During operation of the blower assembly 36, the filters 42 and 44 can become increasingly laden with particles. As increasingly more particles become entrapped in one or more of the filters 42 and 44, a drop in pressure across the filters will occur. This drop in pressure causes a decrease in load of the electric motor 50, when used in conjunction with the cage-type fan 54, and a corresponding increase in the revolutions per minute (RPM) or speed of the electric motor, due to the tendency of the electric motor to approach synchronous speed, which is the speed of the motor at zero load. When the speed increases, the current through the motor 50 decreases. Thus, the speed of the motor 50 can be determined by measuring the current draw of the motor, and, as mentioned above, an increase in the speed of the motor 50 is directly related to a decreased load on the motor. For some types of fans and/or the position of such fans, i.e. whether located before or after the filter, there may actually be an increase in the load of the electric motor 50 as the filter becomes increasingly laden with particles, resulting in a corresponding increase in the current draw of the motor and a decrease in motor speed.

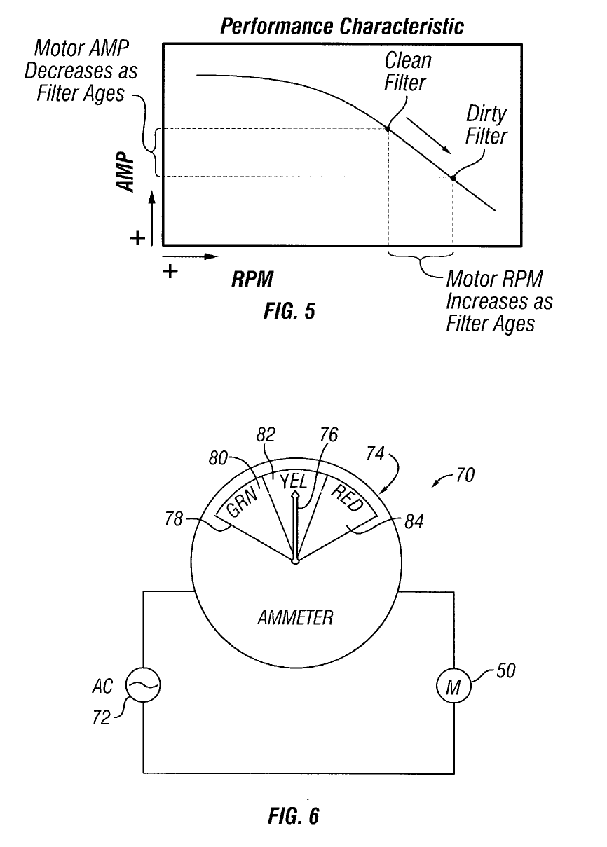

Referring now to FIG. 5, for cage-type fans, the RPM of the motor 50 increases and the current drawn by the motor 50 decreases over time as the filter becomes increasingly laden with particles. The current through the motor 50 is therefore inversely related to the RPM of the motor 50, the exact relationship of which can be derived experimentally and portrayed as the performance curve of FIG. 5. For different fan types as well as different filters and filter combinations, the performance curve may change.

With reference now to FIG. 6, a feedback circuit 70 in accordance with an exemplary embodiment of the invention serves to both operate the motor 50 and determine the filter condition. The feedback circuit 70 includes a power source 72, shown here as an AC power source although a DC power source could be used in many applications, that is electrically connected to the motor 50 and an indicator in the form of an ammeter 74, that is electrically connected in series with the power source 72 and motor 50. As the load on the motor 50 changes, the current draw also changes and can be read directly on the ammeter 74. As shown, the ammeter 74 has a needle 76 that moves in correspondence with the current draw on the motor 50. The ammeter 74 can form part of circuitry (not shown) that includes a comparator and a stored or generated reference current or other predetermined value to determine one or more filter conditions, including a filter change point. A background area 78 of the ammeter 74 can include separate graphical sections 80, 82 and 84 representing different filter conditions, with the section 80 representing a good or acceptable filter condition, the section 82 representing a marginal filter condition, and the section 84 representing a filter change condition. The graphical sections can include colors, words, and/or numerals to identify the filter condition. It will be understood that more or less sections can be provided for indicating more or less stages of the filter condition. Alternatively, the ammeter 74 can be directly marked with numbers without the graphical sections.

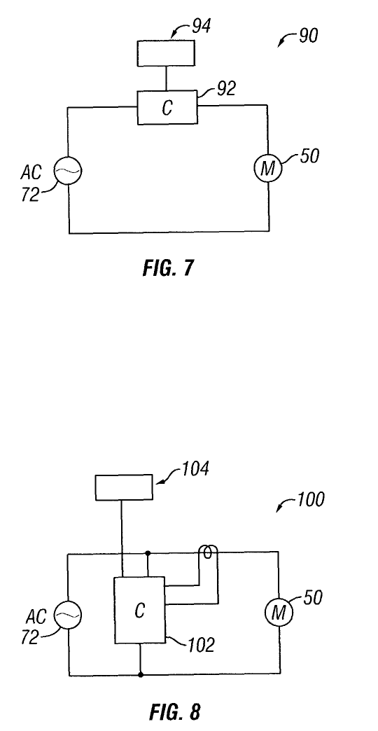

Referring now to FIG. 7, a feedback circuit 90 in accordance with a further embodiment of the invention includes a current sensor circuit 92 that is connected in series with the power source 72 and the motor 50, and an indicator 94 that is connected to the current sensor circuit 92. The current sensor circuit 92 preferably includes a comparator and a stored or generated reference current or other predetermined value to determine one or more filter conditions, including a filter change point. The motor current draw is sensed by the current sensor circuit and used to continuously indicate the filter condition with the indicator 94 during operation of the motor 50. The indicator 94 can be in the form of a single LED, bargraph, LCD display, buzzer, or the like. When a single LED is used, the LED may take the form, for example, of a blinking LED or an LED that changes color from green to amber to red as the filter becomes increasingly laden with particles.

Referring now to FIG. 8, a feedback circuit 100 in accordance with an even further embodiment of the invention is illustrated. The feedback circuit 100 includes a Hall effect current sensor circuit 102, such as a digital amp/clamp meter, to indirectly determine the current in the lead wires of the motor, and an indicator 104 that is connected to the current sensor 102. The amp/clamp meter preferably includes a comparator and a stored or generated reference current or other predetermined value to determine one or more filter conditions, including a filter change point. The indicator 104 can be in the form of a single LED, bargraph, LCD display, buzzer, or the like.

In each of the above circuits, a microprocessor, microcomputer, or other processor configuration (not shown) can be used to receive the sensor signal, compare the signal with one or more predetermined values indicative of a filter change or transitional point, such as a predetermined value on a motor load performance curve, for example as shown in FIG. 5, and drive the indicator in response to the compared signal. The predetermined value(s) can be stored in a nonvolatile memory location of that is accessible by the processor. The processor may also be programmed to hold a display setting when the motor 50 is deactivated. In addition to indicating a filter change point, the processor may also calculate or determine the amount of remaining and/or used filter life and display the results through any known display means, such as an LCD display, alpha-numeric display, and so on.

Instead of or in addition to indicating the filter condition, the power source 70 connected to the motor 50 can be interrupted so that the forced air system, such as the air purifier 5, does not run inefficiently or is always below a motor overload condition.

It is possible to measure the load on the motor 50 by other devices or methods than current measurement, such as by directly measuring RPM through magnetic or inductive pickups, counters, tachometers, sensing gears, optical sensors, or other means for directly measuring the RPM of the motor 50. Any of these devices and methods may be used in conjunction with, or in place of, the current sensor to determine the load on the motor 50 and correlate that load with a condition of the air filter without departing from the broad scope of the present invention.

It will be appreciated by those skilled in the art that changes could be made to the embodiment described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A forced air filtration system comprising:
a housing having an air inlet and an air outlet;
an air filter positioned in an airflow pathway between the air inlet and the air outlet;
a blower assembly having an electric motor with an output shaft and a fan mounted for rotation with the output shaft, the blower assembly being positioned for directing air flow from the air inlet, through the air filter and out of the air outlet;
circuitry operably connected to the electric motor, the circuitry comprising a load sensor for monitoring an electric load of the motor, the load sensor generating a load value dependent on the electric load of the motor; and
an indicator for indicating a condition of the air filter based on the load value.

2. A forced air filtration system according to claim 1, wherein the load sensor comprises a current sensor for measuring a current draw of the electric motor.

3. A forced air filtration system according to claim 2, wherein the current sensor comprises an ammeter connected in series with the electric motor.

4. A forced air filtration system according to claim 3, wherein the indicator comprises:
a display having graphical representation depicting at least a change filter condition; and
a needle operably associated with the ammeter, the needle being movable with respect to the display in response to a change in the current draw of the electric motor to thereby indicate the change filter condition.

5. A forced air filtration system according to claim 4, wherein the graphical representation comprises indicia.

6. A forced air filtration system according to claim 4, wherein the graphical representation comprises a first graphical portion indicative an acceptable filter condition and a second graphical portion indicative of the change filter condition, the needle being movable between the first and second graphical portions.

7. A forced air filtration system according to claim 6, wherein the graphical representation further comprises a third graphical portion between the first and second graphical portions, the third graphical portion being indicative of a marginal filter condition.

8. A forced air filtration system according to claim 2, wherein the current sensor comprises a hall effect sensor for indirectly measuring the current draw of the electric motor.

9. A forced air filtration system according to claim 1, wherein the circuitry comprises a comparator electrically connected to the load sensor for comparing a value of the electric load of the motor to a predetermined value indicative of the filter condition.

10. A forced air filtration system according to claim 9, wherein the predetermined value is a constant current source.

11. A forced air filtration system according to claim 9, wherein the predetermined value is a stored value in a nonvolatile memory.

12. A forced air filtration system according to claim 1, wherein the load sensor comprises means for directly measuring the revolutions per minute of the electric motor.

13. A forced air filtration system according to claim 1, wherein the indicator comprises an audible device.

14. A forced air filtration system comprising:
a housing having an air inlet and an air outlet;
an air filter positioned in an airflow pathway between the air inlet and the air outlet;
a blower assembly having an electric motor with an output shaft and a fan mounted for rotation with the output shaft, the blower assembly being positioned for directing air flow through the air filter and out of the air outlet;
circuitry operably connected to the electric motor, the circuitry comprising:
a current sensor for measuring a current draw of the electric motor, the current sensor generating a load value dependent on the electric load of the motor; and
a comparator electrically connected to the current sensor for comparing the load value to a predetermined value indicative of a filter change point; and
an indicator operably associated with the comparator for indicating at least the filter change point.

15. A forced air filtration system according to claim 14, wherein the predetermined value is a constant current source.

16. A forced air filtration system according to claim 14, wherein the predetermined value is a stored value in a nonvolatile memory.

17. A forced air filtration system according to claim 14, and further comprising means for directly measuring the revolutions per minute of the electric motor.

18. A method for sensing a change point of a filter in a forced air filtration system having an electric blower motor and a fan connected to an output shaft of the blower motor for rotation therewith to thereby direct air through the filter, the method comprising:
monitoring an electric load of the blower motor;
generating a load value dependent on the electric load of the motor; and
indicating a change point of the air filter based on the load value.

19. A method according to claim 18, wherein monitoring the electric load comprises measuring a current draw of the blower motor.

20. A method according to claim 19, wherein measuring the current draw comprises providing an ammeter in series with the blower motor.

21. A method according to claim 20, wherein indicating a filter change point comprises:
displaying a graphical representation depicting at least a change filter condition; and
moving a needle operably associated with the ammeter with respect to the display in response to a change in the current draw of the blower motor to thereby indicate the filter change point.

22. A method according to claim 21, wherein displaying a graphical representation includes displaying a first graphical portion indicative an acceptable filter condition and a second graphical portion indicative of the filter change point, the needle being movable between the first and second graphical portions.

23. A method according to claim 22, wherein displaying a graphical representation further comprises displaying a third graphical portion between the first and second graphical portions, the third graphical portion being indicative of a marginal filter condition.

24. A method according to claim 19, wherein measuring the current draw comprises indirectly measuring the current draw of the electric motor.

25. A method of determining a filter life of an air filter used in a forced air filtration system to alert a user of a dirty-filter condition, the method comprising:
actuating a fan motor to force air through the air filter;
measuring a current passing through the fan motor;
determining a speed of the fan motor from the measured current;
comparing the speed of the fan motor to a predetermined value to determine the filter life; and
actuating an alert if the speed of the fan motor is greater than the predetermined value.
